(19) United States
(12) Patent Application Publication
(10) Pub. No.: US 2005/0237218 A1
(43) Pub. Date: Oct. 27, 2005

(54) AN AUDIO SPEAKER SYSTEM AND METHOD CONTAINING LED LIGHTS

(75) Inventors: YONG TANG, NINGBO (CN); ZHEN WU, MONMOUTH JCT, NJ (US)

Correspondence Address: CHUCK J. CHEN, 14 ARBUTUS WAY, MONMOUTH JCT, NJ, 08852, US

(73) Assignee: SONDPEX CORP OF AMERICA, MONMOUTH JCT, NJ (US)

(21) Appl. No.: 10/907,365

(22) Filed: Mar. 30, 2005

Related U.S. Application Data
(60) Provisional application No. 60/521,324, filed on Apr. 1, 2004.

(51) Int. Cl. G08B 5/22

(52) U.S. Cl. 340/815.45; 181/148; 340/654; 340/691.6; 381/150; 340/693.1

(57) ABSTRACT

An audio speaker system employing mounted LED lights in the body as well as in associated portions of the speaker such as in the speaker grill or the like including optional operation of the lights by independent control as well as control by input and/or output from the mounting speaker or other speakers environmentally associated with the mounting speaker. A method for the use of these items is also provided.

### REFERENCE TO RELATED DISCLOSURES

This application is based on and claims priority from Provisional Application 60/521,324 for “An Audio Speaker System and Method Containing LED Lights” filed on Apr. 1, 2004.

### BACKGROUND OF THE INVENTION

This invention relates generally to an entertainment device and more particularly to an audio speaker system operationally associated with the entertainment device which speaker employs and is operatively connected with mounted LED lights. The lights may be controlled by independent means or they may also be operatively controlled by the input or the output or combinations of input and output from the speaker on which they are mounted as well as from other speakers environmentally associated with the mounting speaker. Thus the speakers may have light with no sound or sound with no light or combinations.

Audio speaker systems have been in the market for many years. In addition LED lights have also been used for many years. See for example, U.S. Pat. No. 5,926,442 entitled “Alarm clock system incorporating a game of skill”. This patent uses LED lights in a toy gun and has a rudimentary noise maker in the same gun but there is no environmental association between the lights and the speaker. Up to the present time, however LED lights have not been used in operative combination with high fidelity audio speaker devices. Certainly various types of lights have been used with such audio speakers. The type of light employed with these high end speakers has, in the past, been generally limited to neon lights. This type of light is not completely satisfactory in that it is generally limited to a single color and if the bulb breaks the entire light will malfunction. Further neon lights have proven to be relatively fragile especially when compared to LED lights. This is especially important in, for example, automotive applications where the light system must be particularly robust.

### SUMMARY OF THE INVENTION

It has now been found that when LED lights are employed in operative combination with an audio speaker system, either in the speaker box itself or in mountings associated with the speaker such as speaker grills or other mounted associated hardware that the composite product is much more user-friendly, robust, and substantially much less likely to be damaged. The speaker system includes at least one and preferably more than one high quality speaker. The speaker or speakers are capable of a relatively high fidelity response with minimal audio distortion.

For a better understanding of the invention, its operational advantages, and the specific objects attained by its uses, reference should be made to the accompanying drawings and descriptive matter which illustrate various embodiments of the invention. Those skilled in the art will appreciate, however, that the invention is capable of other embodiments and of being practiced and carried out in various ways. In this respect, the details of construction disclosed herein, and the arrangements of the components set forth in the following description and appended drawings are for illustrative purposes, only, and are not intended to be limiting in scope.

### BRIEF DESCRIPTION OF THE DRAWINGS

The various aspects which characterize the invention will be better understood and appreciated when consideration is given to the following detailed description, and to the accompanying drawings.

FIG. 1 is a perspective view of an embodiment of a stereo unit of the audio speaker system according to the present invention.

FIG. 2 is a detail view of a speaker grill showing the LED lights mounted in the grill.

FIG. 3 is a perspective view of a controller which can be employed, for example, in a vehicle using the power from a receptacle such as a cigarette lighter or the like with an additional connection to the speaker assembly.

FIG. 4 is a schematic diagram illustrating a circuitry example which may be used with the device of the invention when a volume controller such as that shown in FIG. 3 is employed.

FIG. 5 is a schematic diagram illustrating a circuitry example for the device of the invention without employing the Light-Volume controller device illustrated in FIG. 3.

FIG. 6 is a perspective view of a power connector which may be used to power the LEDs.

### DETAILED DESCRIPTION OF THE INVENTION

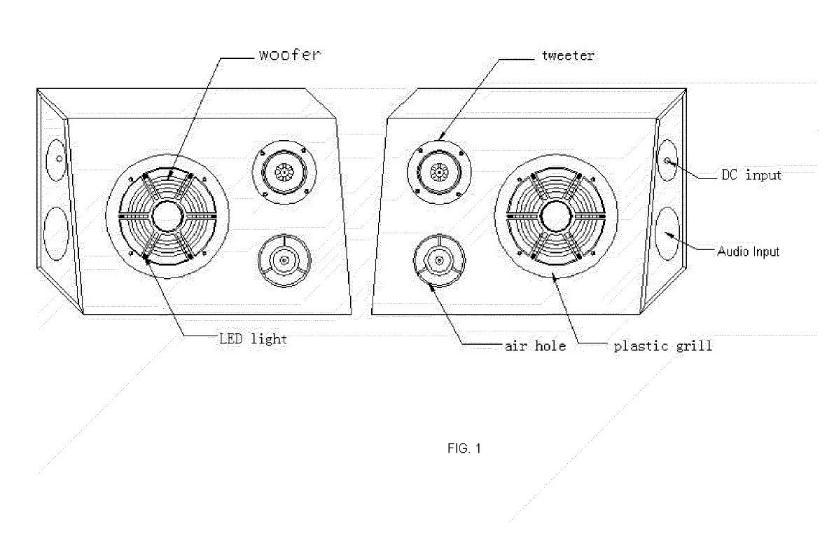

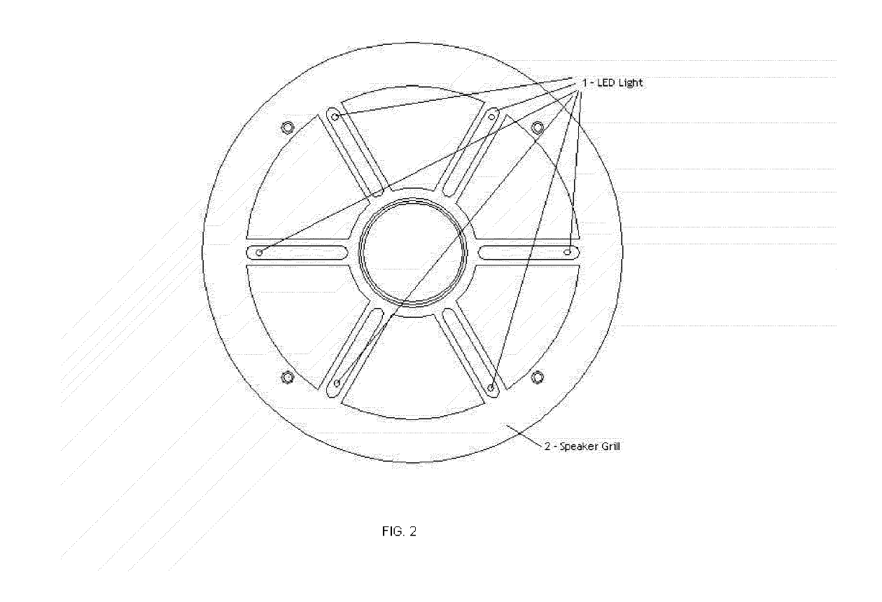

The apparatus detailed in FIG. 1 includes a pair of stereo speaker enclosures each of which contains a woofer and a tweeter as well as air hole and various input devices. In FIG. 1 the plastic grills on the woofers contain LED lights. This is shown in more detail in FIG. 2. The lights may be mounted on any other part of the speaker as well as on the speaker grill.

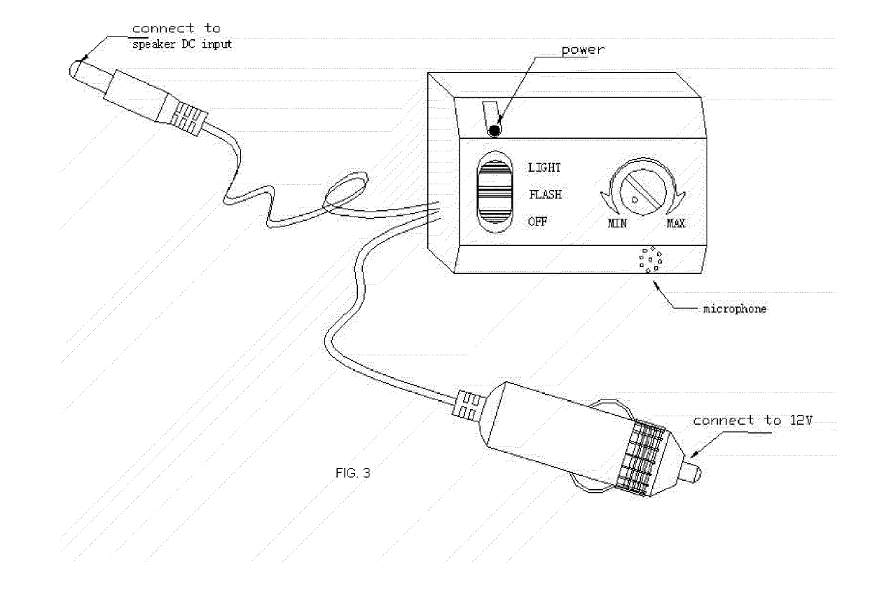

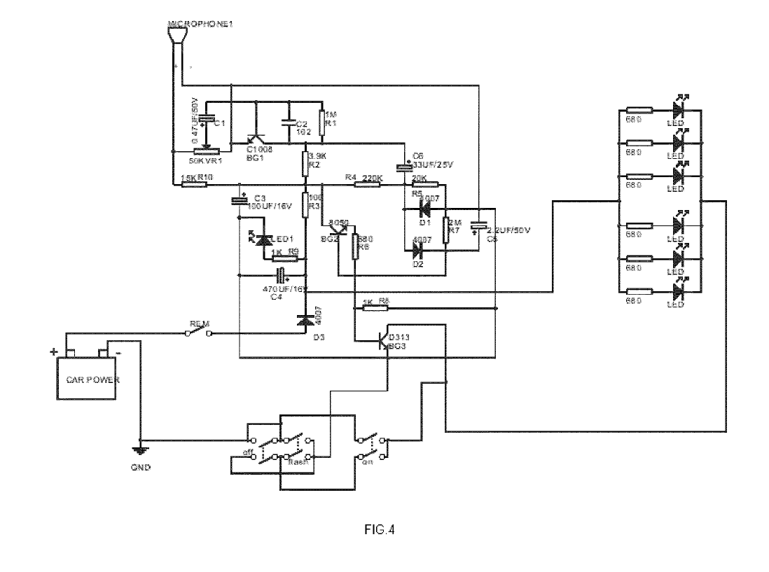

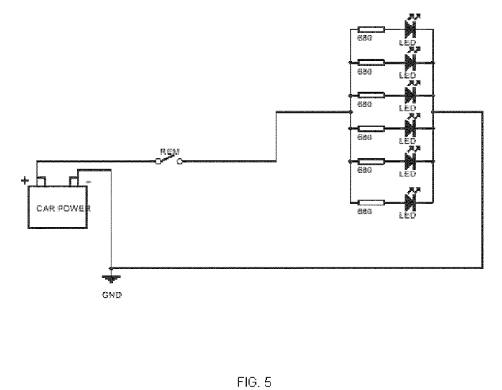

The lights, in turn, may be responsive to controller means such as, for example a Light Volume Controller Device as shown in FIG. 3. This can be accomplished by the circuitry shown in FIG. 4. If a controller is not desired the lights can be powered by a circuit such as that shown in FIG. 5 and the connector shown in FIG. 6. It should be recognized that the FIG. 6 connector is only one means of connecting and other connectors such as to a 12 volt DC power source may also be used. Accordingly, these LED lights may be independently controlled to be responsive only to the electrical input to the speakers or to the audio output from the speakers or to combinations of these. In this way the lights may also operate in environmental response to the audio signal from a nearby speaker, not shown, depending on how the lights and their controller are configured.

Those skilled in the art will be aware of a variety of means which are well-known and used to configure and to control the response of LED lights to power and audio input as well as output. Such means include appropriate conditioning circuitry and interfacing among the LED lights, their mounting locations and selected input signals. As well, those skilled in the art will recognize various other designs, shapes and sizes and configurations for forming the speaker enclosure as well as hardware associated with the speaker enclosure such as speaker grills, air holes, overall design and the like, all of which may perform in substantially the same manner as the embodiments of those elements described and illustrated herein. According to the present invention, it should be understood, that the overall aesthetic design, and the choice of selection and adjustment means used in this embodiment of the present invention are not intended to be limiting.

As is best shown in FIG. 2 the speaker Grill which is preferably made of an elastomeric material, contains light emitting diodes (LED lights). These lights may be turned on by a Power Connector as shown in FIG. 6 as well as a controller as shown in FIG. 3. The lights thus may be independently responsive to a Power Connector or to audio vibrations emanating from either or both of the speakers as shown in FIG. 1. As mentioned above the methods of controlling the lights are well known in the art and various circuitries such as that shown in FIGS. 4 and 5 as well as other appropriate circuitry may be employed.

The various features of novelty which characterize the speaker system of the present invention are pointed out with more particularity in the claims appended hereto and forming a part of this disclosure.

1. An audio speaker system comprising:
a) a speaker enclosure;
b) at least one light emitting diode (LED) mounted on said enclosure.

2. An audio-visual entertainment system having as the sole sound source at least one high fidelity audio speaker, having mounted thereon at least one light emitting diode (LED) as the sole light source.

3. An audio speaker system as defined in claim 1 wherein said diode is responsive to audio input.

4. An audio speaker system as defined in claim 1 wherein said diode is responsive to electrical input.

5. An audio speaker system as defined in claim 1 wherein said diode is responsive to an environmental audio input.

6. An audio entertainment device comprising at least one audio speaker, said speaker having mounted thereon at least one light emitting diode (LED), said light emitting diode being responsive to an input selected from either power or audio or a combination of power and audio.

7. A method for improving the entertainment value of an audio system comprising mounting an LED light on an audio speaker operationally associated with said system, said speaker being the sole source of noise generation in said system and said light being the sole source of light generated in said system.
